(19) United States
(12) Patent Application Publication
(10) Pub. No.: US 2016/0205003 A1
(43) Pub. Date: Jul. 14, 2016

(54) Method to provide inferred intentional data analysis to user(s), using IoT (Internet of Things) devices

(71) Applicant: Formcept Technologies and Solutions Private Limited, Bangalore (IN)

(72) Inventors: Suresh SRINIVASAN, Bangalore (IN); Deekshit MANTAMPADY, Bangalore (IN); Anuj KUMAR, Bangalore (IN)

(73) Assignees: Formcept Technologies and Solutions Private Limited, Bangalore (IN); Suresh SRINIVASAN; Deekshit MANTAMPADY; Anuj KUMAR

(21) Appl. No.: 14/687,162

(22) Filed: Apr. 15, 2015

(30) Foreign Application Priority Data
Jan. 8, 2015 (IN) 137/CHE/2015

(51) Int. Cl. H04L 12/26; H04L 29/08

(52) U.S. Cl. CPC H04L 43/08; H04L 67/10

(57) ABSTRACT

The present invention provides a method to provide inferred intentional data analysis to user (s), using sensory data from IoT devices. The method includes step of acquiring plurality of sensory data from one or more IoT devices present in one or more locations, wherein the sensory data is acquired through a DCU (Data Control Unit). The acquired sensory data is routed through DCU to store and collate in the cloud server. The stored sensory data is analyzed in the cloud server to provide the information based on the analysis of stored sensory data, wherein the obtained information is sent to plurality of smart devices. Furthermore, the user's intention is received through the smart devices and stored in the cloud server. Finally, the user's intention is filtered and processed for decision making in cloud server by using sensory data acquired from chosen set of IoT devices as per user's intention.

This application claims priority to India Patent Application number 137/CHE/2015, filed Jan. 8, 2015.

### DESCRIPTION OF THE INVENTION

The following specification particularly describes the invention and the manner in which it is to be performed.

### TECHNICAL FIELD OF THE INVENTION

The present invention relates to a method to provide inferred intentional data analysis to user (s) using IoT (Internet of Things) devices. More particularly, the present invention relates to analysis of the data received from the chosen set of IoT devices based on user's intention.

### BACKGROUND OF THE INVENTION

The Internet of Things (IoT) is a technique in which objects or people are provided with unique identifiers and has the ability to transfer data over a network without requiring human-to-human or human-to-computer interaction. IoT has evolved from the convergence of wireless technologies, Micro-Electro Mechanical Systems (MEMS) and the Internet. Particularly, the IoT refers to various information sensing devices, such as sensors, RFID devices, the GPS system, infrared sensors, laser scanners, gas transducers, etc. The IoT is based on the idea that each object, not just computers and computer networks, can be readable, recognizable, locatable, addressable, and controllable via an IoT communications network (e.g., an ad-hoc system or the Internet). The main objective of the IOT is to realize connections between devices, devices and persons, and networks for identifying, managing and controlling the devices from a remote location.

Various types of conventional methods using the IoT devices are known in the prior art, wherein most of them use the IoT devices only to acquire information from the IoT devices. Typically, the existing method collects, stores and provides analytics on the sensory information from the IoT devices and lacks in correlating with external data to provide any intelligent decision using stored sensory information.

The abilities of the existing methods are very focused to that particular device only. These methods do not have the capability of taking external related data source and augment the sensor data or correlate with sensor data i.e. the existing methods are not capable of understanding or inferring the intent of the user and provide related intelligent content to the user. For example, though the textile industries may adopt latest technologies to optimize their production cost by having certain IOT devices to monitor the machines and predict the downtime etc., the information from these IoT devices (IOT devices to the user) may help the textile industries to adopt a process to eliminate wastages or to prevent machine downtime by preventive maintenance etc. However, the existing method fails to correlate with external data to expedite actions. In the above example (textile industry), the IOT devices can point out that the machines can operate for 4 months without any issues, but it further fails to take intelligent decision i.e. if there is a festival season in next 4 months and to meet the demand, the machines has to be operational for more hours and with the current condition of machines (data from IOT devices that is monitoring the machines), if the preventive maintenance actions are not taken at that time then there would be significant loss in potential revenue.

Hence, there is a need for a method, which is active, intelligent and has decision making abilities to understand or infer the intent of the user and provide related content to the user (s) to take necessary intelligent action as per user's intention, which may help the user in accurate planning and executing the task and also the method needs to correlate with external data sources to derive intelligent actions.

### SUMMARY OF THE INVENTION

The present invention overcomes the drawbacks in the prior art and provides a method to provide inferred intentional data analysis to user (s) using IoT devices. In most preferred embodiment, the method includes the step of acquiring plurality of sensory data from one or more IoT devices present in one or more locations through a DCU (Data Control Unit). The acquired sensory data is routed through DCU to be stored in a cloud server and collating the acquired sensory data in the cloud server. The stored sensory data is analyzed in the cloud server to provide the information based on analyzed sensory data, wherein the obtained information after the analysis of sensory data is sent to a plurality of smart devices. Furthermore, the method receives user's intention through the plurality of smart devices and stores the user's intention in the cloud server. Finally, the user's intention is filtered and processed for decision making in the cloud server by using the sensory data acquired from the chosen set of IoT devices as per user's intention.

In a preferred embodiment of the invention the user's intention may be inferred based on a plurality of parameters such as time, location, previous choices of the user.

In preferred embodiment of the invention, the inference of the user's intention and analysis of data in the cloud server is performed using Formal Concept Analysis (FCA).

In another embodiment of the invention, the method further comprises of creating and processing decisions automatically using the DCU based on the context of user's intention

In a preferred embodiment of the invention, the decision is altered or modified by the user (s) based on the available information on the smart device.

In preferred embodiment of the invention, the sensory data is any of data obtained from the IoT devices but not limited to temperature, weight, levels of liquids, speed, location, light, pressure, availability of equipment, occurrence of events or stored data.

In further embodiment of the invention, the method further comprises of creating and processing decisions automatically based on the context of user's intention.

In further embodiment of the invention, the method further comprises of correlating the analyzed sensory data with data from an external source to initiate and complete the user's intention.

The present invention eliminates the passive methods used only to acquire the sensory information from IoT devices. The invented method is active, intelligent and has decision making abilities based on the analysis of the data received from the chosen set of IoT devices as per user's intention. It is also easy to use and simple and is more suitable for applications in office, kitchen, pharmacies, industries and product and service based companies etc.

It is to be understood that both the foregoing general description and the following details description are exemplary and explanatory and are intended to provide further explanation of the invention as claimed.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates a method flow for providing inferred intentional data analysis to user (s), using IoT devices, according to one embodiment of the invention.

FIG. 2 illustrates an example for providing inferred intentional data analysis to user (s), using IoT devices or sensors, according to one embodiment of the invention.

FIG. 3 illustrates an example for providing inferred intentional data analysis to user (s) for selecting right IoT devices or sensors, according to one embodiment of the invention.

FIG. 4 illustrates an example for providing inferred intentional data analysis to user (s), using IoT devices or sensors in the kitchen, according to one embodiment of the invention.

FIG. 5 illustrates an example for providing inferred intentional data analysis to user (s), using IoT devices in the meeting room, according to one embodiment of the invention.

FIG. 6 illustrates an example for providing inferred intentional data analysis to user (s), using IoT devices in the car, according to one embodiment of the invention.

### DETAILED DESCRIPTION OF THE INVENTION

Reference will now be made in detail to the description of the present subject matter, one or more examples of which are shown in figures. Each embodiment is provided to explain the subject matter and not a limitation. These embodiments are described in sufficient detail to enable a person skilled in the art to practice the invention, and it is to be understood that other embodiments may be utilized and that logical, physical, and other changes may be made within the scope of the embodiments. The following detailed description is, therefore, not be taken as limiting the scope of the invention, but instead the invention is to be defined by the appended claims.

The term ‘Formal Concept Analysis (FCA)’ as claimed in various embodiments defines a principled way of deriving a concept hierarchy or formal ontology from a collection of objects and their properties, wherein each concept in the hierarchy represents the set of objects sharing the same values for a certain set of properties and each sub-concept in the hierarchy contains a subset of the objects in the concepts above it.

The term ‘smart device’ as claimed in the various embodiments refers to an electronic device, generally connected to other devices or networks via different protocols such as Bluetooth, NFC, Wi-Fi, 3G, etc., that can operate to some extent interactively and autonomously and it also used for smart computing and communication in a very short time, in part, acting as a useful enabler for the Internet of Things.

The term ‘inferred intentional data analysis’ as claimed in the various embodiments refers to concluding the user (s) intention by analyzing the data available from the chosen set of sensors or IoT devices. The data analysis is done for a particular context as per user's intention.

The present invention provides a method to provide inferred intentional data analysis to user (s), using IoT (Internet of Things) devices. The method includes the step of acquiring plurality of sensory data from one or more IoT devices present in one or more locations through a DCU (Data Control Unit) and stored in a cloud server. The stored sensory data is analyzed in the cloud server to provide the information based on analyzed sensory data, wherein the obtained information after the analysis of sensory data is sent to a plurality of smart devices. Furthermore, the method receives user's intention through the plurality of smart devices and the user's intention is transmitted to the cloud server. Finally, the user's intention is filtered and processed for decision making in the cloud server by using the sensory data acquired from the chosen set of IoT devices as per user's intention.

The present invention eliminates the passive methods used only to acquire the sensory information from IoT devices. The invented method is active, intelligent and has decision making abilities based on the analysis of the data received from the chosen set of IoT devices as per user's intention. It is also easy to use and simple and is more suitable for applications in office, kitchen, pharmacies, industries and product and service based companies etc.

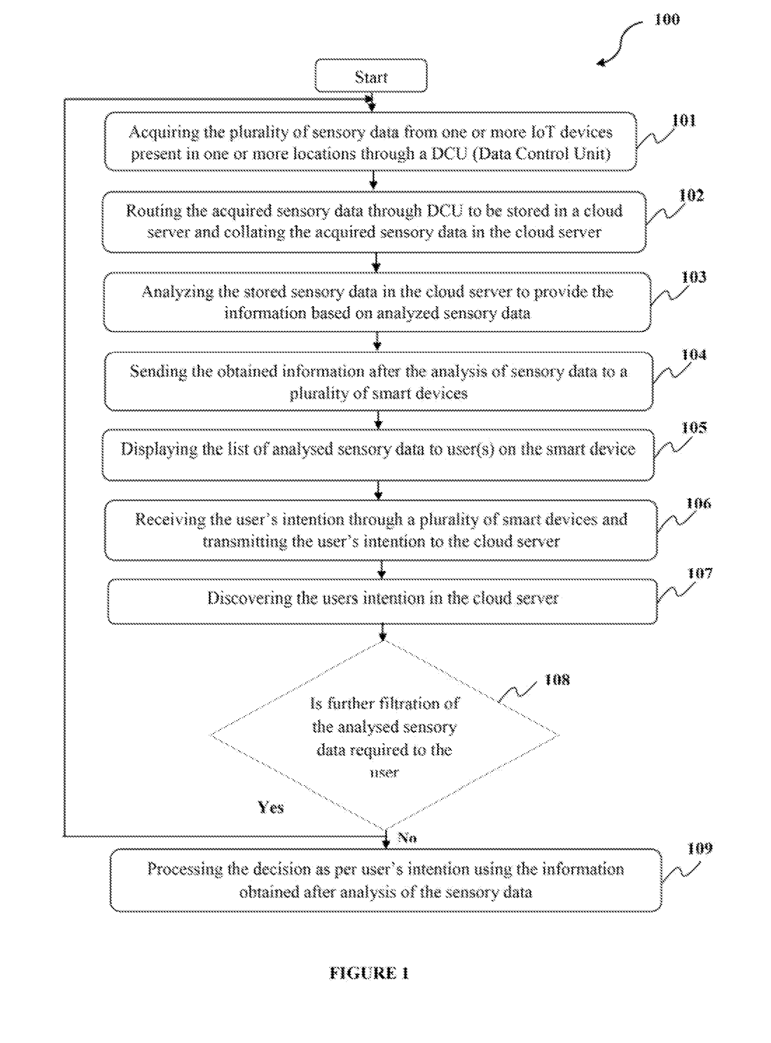

FIG. 1 illustrates a method flow for providing inferred intentional data analysis to user (s), using IoT (Internet of Things) devices or sensors, according to one embodiment of the invention. The method (100) comprises the steps of, at step (101), the method is configured to acquire the plurality of sensory data from one or more IoT devices present in one or more locations through the DCU (Data Control Unit). At step (102), the acquired sensory data is routed through DCU to be stored in a cloud server and collating the acquired sensory data in the cloud server. At step (103), the stored sensory data is analyzed in the cloud server using FCA (Formal Concept Analysis), wherein the FCA creates concept lattice from the sensory data obtained from chosen set of IoT devices based on user's intention. The analysis of the sensory data obtains the information, wherein the obtained information is sent to the plurality of smart devices at step (104). At step (105) the list of analyzed sensory data is displayed to user(s) on the smart device. Furthermore at step (106), the method receives user's intention through the plurality of smart devices and the user's intention is transmitted to the cloud server and the user's intention is discovered in the cloud server at step (107). At step (108) the user's intention is further filtered and finally at step (109), the user's intention is processed for decision making in the cloud server by using the sensory data acquired from the chosen set of IoT devices as per user's intention.

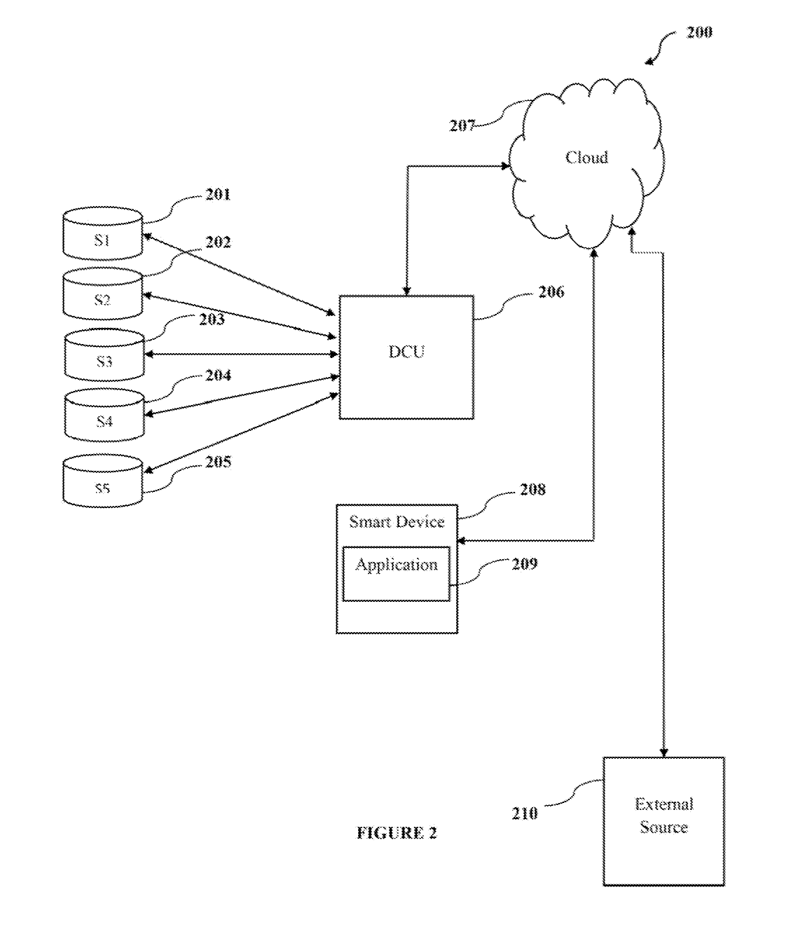

FIG. 2 illustrates an example for providing inferred intentional data analysis to user (s) using IoT devices or sensors, according to one embodiment of the invention. In the preferred embodiment, the example (200) illustrates the use of sensors (201, 202, 203, 204 and 205), the DCU (Data Control Unit) (206), the cloud server (207), and one or more smart devices (208). The plurality of sensors (201, 202, 203, 204 and 205) measures various attributes with respect to their location. The DCU (206) acquires the sensor data from the plurality of sensors (201, 202, 203, 204 and 205) and stores the acquired data in the cloud server (207). The acquired data in the cloud server (207) is analyzed using Formal Concept Analysis (FCA) to create a concept lattice. Further, along with the acquired data in the cloud server (207), the data from external data source (210) is correlated to create augmented concept lattices which is used to derive user intentions. The analyzed information is sent to the applications (209) installed on to the smart device (208) for interaction with the users. Based on the user interaction, further different concept lattices can be filtered. In the analysis the sensory data is analyzed from the chosen set of IoT devices based on the user's intention. The information obtained after analyzing the sensory data is sent to the smart device (208), wherein the smart device (208) displays different options to the user based on the information determined from the analyzed sensory data, wherein the options are selected according to the user's intention.

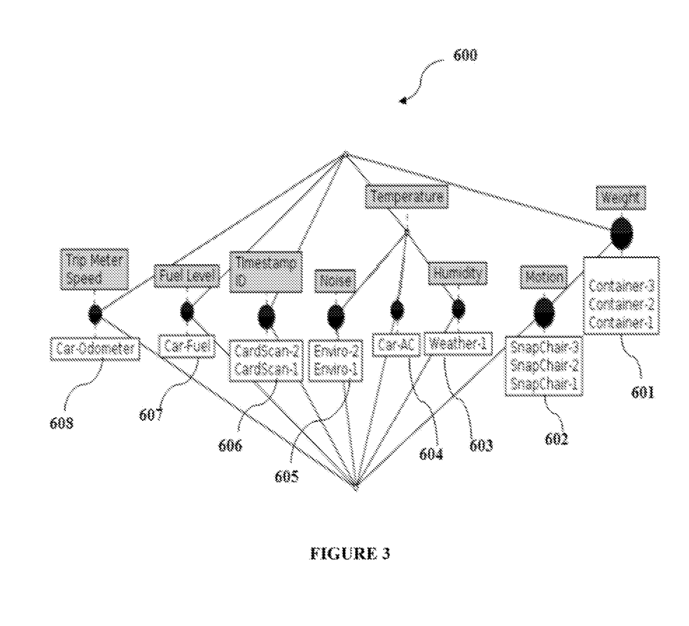

FIG. 3 illustrates an example for providing inferred intentional data analysis to user (s) for selecting right IoT devices or sensors, according to one embodiment of the invention. In the preferred embodiment, the example illustrates the method (600) to acquire the plurality of data from one or more IoT devices present in one or more IoT device groups. The various IoT devices may be Container Sensor (CS) (601) CS 1, CS 2, CS 3, Snap Chair sensor (SCS) (602) SCS 1, SCS 2, SCS 3, Environment Sensor (ES) (605) ES 1, ES 2, card-scan sensor 1 (606), card-scan sensor 2, weather sensor (603), car fuel sensor (607), car odometer sensor (608) and car AC sensor (604). The CS 1, CS 2 and CS 3 (601) may be located at the kitchen. The SCS 1, SCS 2, SCS 3 (602), ES 1 and ES 2 (605) may be located inside the meeting room of an office. The card-scan sensor 1 (606) and card-scan sensor 2 (606) may be located at the entrance of the meeting room. The weather sensor (603) may be located at the India Meteorological Department (IMD). The car fuel sensor (607), car odometer sensor (608) and car AC sensor (604) may be located in the car.

Considering an example, to cook ‘carrot dessert’, in this case user starts selecting the available ingredients in the kitchen. Firstly, the user (s) selects carrot, upon selecting carrot, the FCA provide the list of recipes having carrot to the smart device. Similarly, the user (s) selects ghee along with carrot, upon selecting ghee and carrot, the FCA further filters the recipes and provide list of recipes having carrot and ghee to the smart device. Further, the user (s) may select sugar and almonds along with carrot and ghee, then the FCA further filters the recipes and provide list of recipes having carrot, ghee, sugar and almonds to the smart device. Hence, the user (s) may infer to select the available recipe from the list of recipes on the smart device based on the information obtained from analyzed sensory data using FCA, wherein sensory data is obtained from the chosen set of container sensors having carrot, ghee, sugar and almonds.

For example, consider user (s) intents to cook “GajarkaHalwa”. In this case, the user selects the recipe for preparing “GajarkaHalwa” from the available list of recipes obtained using FCA. Further, the user enters the quantity of “GajarkaHalwa” to be cooked based on the number of persons (example for 5 persons) on the smart device. The IoT devices will determine the weight of the ingredients in the containers based on the user's intention. The determined sensory data is processed using FCA to create concept lattice. The created concept lattice identifies the relevant IoT devices i.e. CS (601) CS 1, CS 2 and CS 3, that may provide the relevant data related to weight attribute such as carrot, ghee, sugar and milk. Furthermore, the smart device displays the available ingredients that are sufficient for the specified number of persons. If the ingredients are not sufficient for the specified number of persons, then the smart device may recommend the user to cook the different recipes using the available ingredients or may recommends the user (s) to buy the ingredients from the super market.

In the discussed embodiments, if the particular ingredient is not available in the kitchen, the application in the smart device notifies the user about the supermarket in which the particular ingredient is available at that particular moment to purchase. Hence, the present invention provides intelligence, wherein the information obtained from the analysis of sensory data can be correlated to the external data sources and an intelligent decision is made as per user's intention.

In further embodiment of the invention, the decisions are made and processed automatically using the ACU based on the context of user's intention, wherein the processed information is displayed on the smart device as per the context of user's intention. The user's intent may be inferred by the present method automatically based on various parameters such as time, location, previous choices of the user, etc. Also, the user's intent may be discovered by the present method based on the input provided by the user. Considering an example, when the user accesses the application on the smart devices at home, based on the location and based on user's intent (in this case cooking), the method prompts the recipes on the smart device as per the ingredients available at home. In this case, the example talks about the particular context, where the recipes are explored. When the user selects few ingredients from the kitchen, then based on the sensory data obtained from chosen set of IoT devices, the FCA in the cloud server identifies the recipes that can be cooked and further the recipes are filtered based on the availability of the ingredients. Now if the application on the smart device is accessed in a super market, then based on geo location, the context is identified as “Buying Groceries” and the list will be shown based on the availability of ingredients or ingredients that need to be purchased for a recipe etc. In this case, the application installed on the smart device communicates the “Buying groceries” context to the cloud server, and the FCA in the cloud server interacts to the IoT devices through DCU to get the sensory data i.e. the ingredients that needs to be replenished.

In one embodiment, the user may utilize multiple contexts to solve multiple intentions. For example, in the recipe case, suppose, there isn't enough “carrot” available within the house, and the user may get an alert signal from car sensor that his/her partner is on the way driving near the super market. In this case, a request may be sent to the partner to buy some “carrot” on the way.

In further embodiment, lets us consider the user is in office and intents to cook ‘palakpaneer’ after reaching home. In this case, the user checks for the availability of the ingredients at home to cook ‘palakpaneer’ wherein the availability of the ingredients are verified using the smart device. The smart device provides available ingredients to the user based on FCA, wherein the FCA provides the information to smart device by obtaining the sensory data from the chosen set of container sensors as per user (s) intention in the kitchen. If the particular ingredient is not available to cook ‘palakpaneer’, then the user is notified to buy that particular ingredient from the super market which is located on the way to home from office.

In the further embodiment, let us consider the example where the user's intention is to determine the presence and absence of an employee at office. In this case, the IoT devices at the location figures out the target dataset that may be used to infer employee's presence and absence in the office. In the preferred embodiment, the IoT devices acquire the scanned records of employee IDs and the timestamp, which may determine the presence and absence of an employee in the office. This acquired data is processed using FCA to create concept lattice. The created concept lattice identifies the relevant IoT devices i.e. card-scan sensor 1 (606) and card-scan sensor 2 (606), that may provide the relevant data such as employee IDs and the timestamp. Further, the method determines the location and context information of the selected IoT devices i.e. card-scan sensor 1 (606) and card-scan sensor 2 (606), and figures out that the card scanners (606) located at the entrance of the meeting-room will be sufficient to determine the presence and absence of employee at office. Accordingly, the method further applies the odd or even scan logic based on the current time to figure out the presence and absence of the employee. For example, in this case odd means present and even means absent.

In further embodiment, the invention describes the use of car fuel sensor (607), car odometer sensor (608) and car AC sensor (604) in the car. These sensors determine weight, fuel level, speed, trip meter and temperature inside the car to take intelligent decisions. Consider the example where the user's intention is to drive the car to the destination. In this case, the user enters the destination in the smart device. The smart device identifies the distance and route to reach the destination using GPS device. Further, in this case, the IoT devices in the car determine the root attribute such as fuel level and fuel efficiency. The determined data is processed using FCA to create concept lattice. The created concept lattice identifies the sensory data from the relevant IoT devices i.e. car fuel sensor (607), car odometer sensor (608), car AC sensor (604), and weather sensor (603) to determine the information such as fuel level and fuel efficiency of the car, wherein the information obtained from analyzed sensory data is sent to the smart device. In the preferred embodiment, if the fuel in the car is not sufficient to reach the destination, then the smart device indicates the user that, the car may travel certain distance but cannot reach the destination with the available fuel and the fuel needs to be refilled. Further, the method correlates with the external data and identifies the nearer petrol stations on the way to user's destination and suggests the user to refill the petrol.

In the preferred embodiment, consider if the number of person travelling in the car are more (for example 7 number of persons). In this case, the IoT devices in the car determine the root attribute such as the efficiency of the car by acquiring the factors such as overall carry load of the car, use of A/c, temperature, weather, kilometers (kms) travelled at a particular speed and the acceleration. The determined sensory data is processed using FCA to create concept lattice. The created concept lattice selects the relevant IoT devices i.e. car fuel sensor (607), car odometer sensor (608), car AC sensor (604), and weather sensor (603) and determines the efficiency of the car by effectively calculating the impact of the load, weather and temperature at which AC is running while travelling. Hence, due to increase in car load, the fuel efficiency of the car decreases and fails to travel certain distance to reach the destination. Further, the information obtained from analyzed sensory data is sent to the smart device, wherein the information includes the notification that the user needs to fill the petrol at the nearest petrol station due to decreased efficiency of the car.

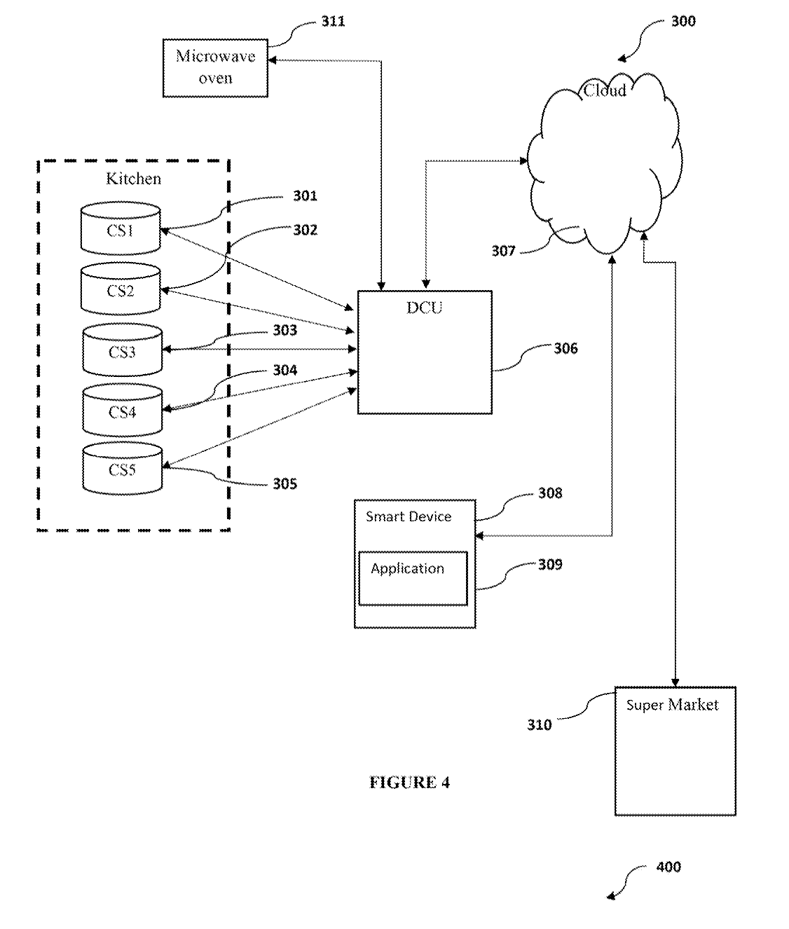

FIG. 4 illustrates an example for providing inferred intentional data analysis to user (s), using IoT devices in the kitchen, according to one embodiment of the invention. In the preferred embodiment, the example (300) illustrates the use of the Container Sensors (CS) CS 1 (301), CS 2 (302), CS 3 (303), CS 4 (304) and CS 5 (305), a DCU (306), the cloud server (307), and one or more smart devices (308). The CS 1 (301), CS 2 (302), CS 3 (303), CS 4 (304) and CS 5 (305) contain various ingredients such as sugar, carrot, spices, salt, vegetables, dairy products etc. The CS 1 (301), CS 2 (302), CS 3 (303), CS 4 (304) and CS 5 (305) are connected to the DCU (306). The DCU (306) acquires the sensor data from the plurality of Container Sensors (301, 302, 303, 304, and 305) and stores the acquired data in the cloud server (307). The acquired data in the cloud server (307) is analyzed using Formal Concept Analysis (FCA) to create a concept lattice which includes the root attributes that are related to identifying the available ingredients and generating one or more recipes based on the identified ingredients. The information obtained after analyzing the sensory data is sent to the application (309) installed on the smart device (308), wherein the information comprises one or more number of recipes to the user (s) based on the ingredients present in the kitchen. Let us consider the example in which the user (s) selects the particular recipe to be processed from the list of recipes displayed in the smart device. Further, the user enters the quantity of meal to be cooked based on the number of persons (example for 5 persons). The recipe is further filtered and notifies the user, whether the particular ingredients used in the selected recipe are sufficient to cook the meal for the number of persons entered. If the ingredients are not sufficient for the number of persons then the smart device may recommend the user to cook the different recipes using the available ingredients or recommends the user (s) to buy from the market. So in this case, the user (s) has no intention to cook particular recipe, but after exploration, the user (s) intent is identified and based on the intent the platform provides few intelligent options.

In the further embodiment, let us consider the example where the user's intention is to cook ‘carrot dessert’ and the main ingredients to cook the ‘carrot dessert’ to be carrot, sugar and ghee. In this case, the container sensors (301, 302, 303, 304, and 305) will determine the weight of the ingredients in the container and sends the data to the DCU (306). The acquired data from the DCU (306) is stored in the cloud server (307). The stored data in the cloud server (307) is analyzed using FCA to create concept lattice, wherein the concept lattice includes choosing the set of the IoT devices having the ingredients such as carrot, sugar and ghee used for preparing carrot dessert as per users intention. The determined information after the analysis is provided on to the smart device (308) as per the user (s) intent, such as the availability of ingredients are sufficient to cook the ‘carrot dessert’ for the specified number of persons or more quantity of ingredients are required.

In the discussed embodiments, if the particular ingredient is not available in the kitchen, the application (309) in the smart device (308) notifies the user about the supermarket (310) in which the particular ingredient is available at that particular moment to purchase. Hence the present invention provides intelligence, wherein the information obtained from the analysis of sensory data can be correlated to the external data sources (210) and an intelligent decisions is made as per user's intention.

In further embodiment, the DCU (306) interacts with the smart home appliances such as microwave oven (311), air conditioner, TV etc. to accomplish the task intelligently as per user's intention. For example considering that a microwave oven (311) is used in the preparation of the recipe selected by the user. In the selected recipe the temperature of microwave oven (311) needs to be set to 180 degree Celsius, hence in this case the DCU (306) interacts with the microwave oven (311) to set the temperature automatically as per defined in the recipe.

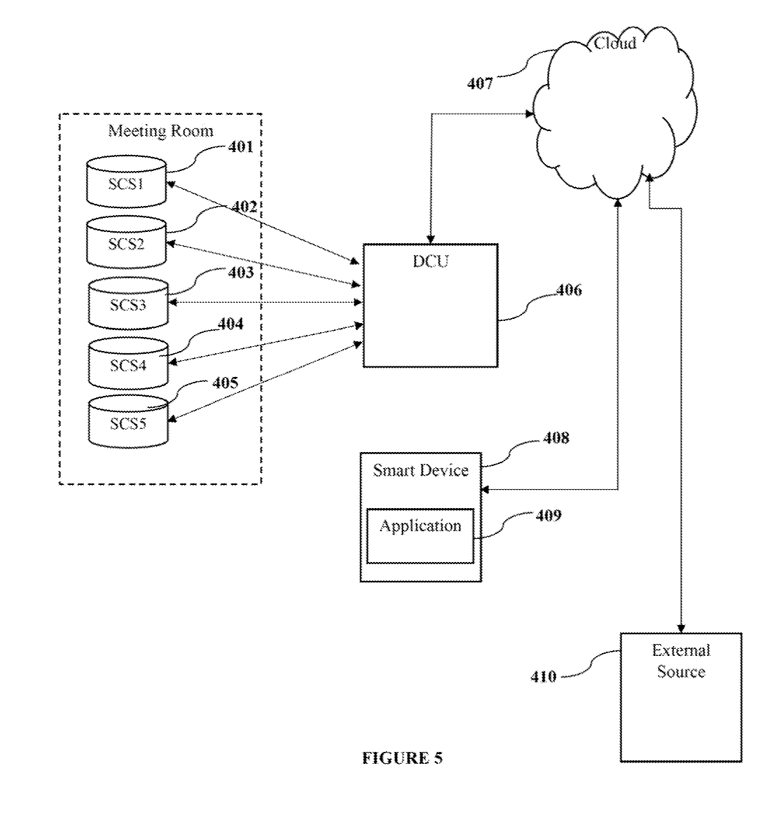

FIG. 5 illustrates an example for providing inferred intentional data analysis to user (s), using IoT devices in the meeting-room, according to one embodiment of the invention. In the preferred embodiment (400), the invention describes the use of the Snap Chair Sensors (SCS) SCS 1 (401), SCS 2 (402), SCS 3 (403), SCS 4 (404), SCS 5 (405), the DCU (406), the cloud server (407) and the smart device (408). One or more SCS (401, 402, 403, 404 and 405) are mounted on to the plurality of snap chairs located in the meeting room to determine the weight and motion of the person sitting on the snap chair. Consider the example where the user's intention is to check whether the meeting room is occupied or not. In this case, the DCU (406) acquires the sensor data from the plurality of SCS (s) (401, 402, 403, 404 and 405) and stores the acquired data in the cloud server (407). The stored data in the cloud server (407) is analyzed using FCA to create concept lattice, wherein the concept lattice includes the weight on the snap chairs which determines the occupancy of the snap chairs in the meeting room i.e., if the weight measured by the IoT devices on the snap chair is more than the snap chair is inferred to be occupied and if the weight is less than the snap chair is inferred not to be occupied. Hence the occupancy of the meeting room can be analysed by determining the occupancy of the snap chairs. The determined information after the analysis is provided on to the smart device (408) as per the user (s) intent such as the availability of meeting room for that particular time for meeting for the specified number of persons.

In the preferred embodiment, the Environment Sensors (ES 1 and ES 2) are used to determine the effectiveness of the meeting held in the meeting room based on the activities such as change in weight and noise of the persons inside the meeting room. If the meeting room becomes noisy especially by means of applause and weight varies across most of the snap chairs, then FCA determines that it as an ovation event. If there are certain moments of silence with a constant noise variation wherein only speaker is talking and weight is not changing much, then it can be inferred that all the attendees are listening patiently and the session is effective.

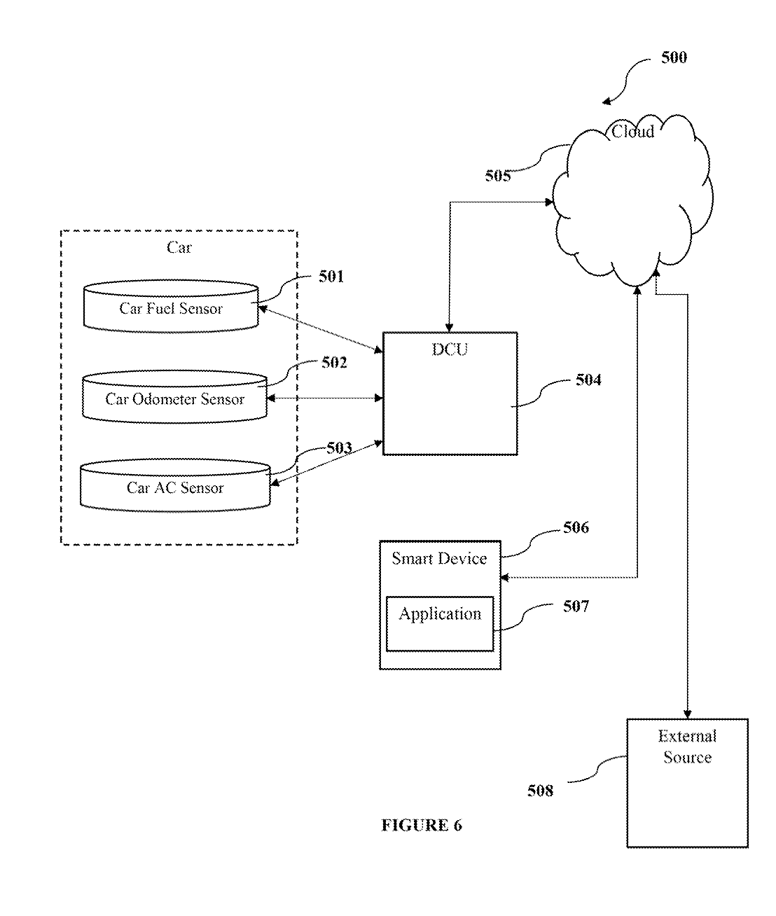

FIG. 6 illustrates an example for providing inferred intentional data analysis to user (s), using IoT devices or sensors in the car, according to one embodiment of the invention. In the preferred embodiment (500), the invention describes the use of car fuel sensor (501), car odometer sensor (502) and car AC sensor (503) in the car, These sensors (501, 502 and 503) determine weight, fuel level, speed, trip meter and temperature inside the car. In the preferred embodiment, consider the example where the user's intention is to measure the “fuel efficiency of a car”. In this case, the DCU acquires the sensory data from IoT devices and stores the acquired data in the cloud server (505). The stored data in the cloud server (505) is analyzed using FCA to create concept lattice which includes the root attributes that are related to measuring the fuel efficiency of the car such as overall carry load of the car, use of A/c, temperature, weather, kilometers (kms) travelled at a particular speed and the acceleration are determined. The determined information after the analysis is provided on to the smart device (506) as per the user (s) intent such as determining the fuel efficiency of the car.

The above embodiments may be further extended to use in a number of cases. For example, if the user (s) has to measure the amount of water being wasted due to dripping taps then, a water sensor or a pressure sensor is attached to measure the impact of drop at a particular timestamp. Accordingly, the user (s) can infer the amount of water being wasted by the dripping tap over a particular time.

The present invention eliminates the passive methods used only to acquire the sensory information from IoT devices. The invented method is active, intelligent and has decision making abilities based on the analysis of the data received from the chosen set of IoT devices as per user's intention. It is also easy to use and simple and is more suitable for applications in office, kitchen, pharmacies, industries and product and service based companies etc.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

We claim:

1. A method to provide inferred intentional data analysis to user (s), the method (100) comprising the steps of:
a. acquiring a plurality of sensory data from one or more IoT devices present in one or more locations through a Data Control Unit (DCU);
b. routing the acquired sensory data through DCU to be stored in a cloud server and collating the acquired sensory data in the cloud server;
c. analyzing the stored sensory data in the cloud server to provide information based on the analysis, wherein the determined information from the analysis of sensory data is sent to a plurality of smart devices;
d. receiving the user's intention through a plurality of smart devices and transmitting the user's intention to the cloud server;
filtering and processing the user's intention for decision making in the cloud server by using the sensory data acquired from the chosen set of IoT devices as per user's intention;

2. The method (100) as claimed in claim 1, wherein the uses intention may be inferred based on a plurality of parameters such as time, location and previous choices of the user.

3. The method (100) as claimed in claim 1, wherein the decision is altered or modified by the user (s) based on the user's intention.

4. The method (100) as claimed in claim 1, wherein the decision is altered or modified by the user (s) based on the available information on the smart device.

5. The method (100) as claimed in claim 1, wherein the smart device is configured to provide the analyzed data to the users) and acquire user's intention.

6. The method (100) as claimed in claim 1, wherein the smart devices are any of the computing devices but not limited to smart phone, tablet, PDA, PC's, laptops.

7. The method (100) as claimed in claim 1, wherein the sensory data is any data obtained from the IoT devices comprising of:
a. temperature;
b. weight;
c. levels of liquids;
d. speed;
e. location;
f. light;
g. pressure;
h. availability of equipment;
i. occurrence of events; or
j. stored data.

8. The method (100) as claimed in claim 1, wherein inference of the user's intention and analysis of data in the cloud server is performed using Formal Concept Analysis (FCA).

9. The method (100) as claimed in claim 1, wherein the user's intention is inferred based on contexts.

10. The method (100) as claimed in claim 1, wherein the context is set using Formal Concept Analysis (FCA).

11. The method (100) as claimed in claim 1, wherein the method further comprises of correlating the analyzed data with data from an external source to initiate and complete the user's intention.

12. The method (100) as claimed in claim 1, wherein the method further comprises of creating and processing decisions automatically using the DCU based on the context of user's intention.
